(19) United States
(12) Patent Application Publication
(10) Pub. No.: US 2011/0250571 A1
(43) Pub. Date: Oct. 13, 2011

(54) NUMBER LINE TOOL AND METHOD

(76) Inventors: Mickelle Weary, Kirkland, WA (US); Catherine Twomey Fosnot, New London, CT (US); Beth Dudycha, Mercer Island, WA (US); Laura Koch, Seattle, WA (US); David Fedchenko, Seattle, WA (US); Nigel J. Green, Bellevue, WA (US); Aja M. Hammerly, Seattle, WA (US); Daniel R. Kerns, Mercer Island, WA (US); Rebecca M. Lewis, Tacoma, WA (US); Slavi Marinov Marinov, Varna (BG); Valentin Mihov, Sofia (BG); Petia Radeva, Sofia (BG)

(21) Appl. No.: 13/082,347

(22) Filed: Apr. 7, 2011

Related U.S. Application Data
(60) Provisional application No. 61/321,843, filed on Apr. 7, 2010.

(51) Int. Cl. G09B 5/00

(52) U.S. Cl. 434/188

(57) ABSTRACT

A computer-implemented method for teaching math is disclosed. The method comprises displaying a number line graphic to indicate a relative order between numbers; generating a first problem comprising numbers at least some of which are indicated on the number line graphic; selectively providing guidance for solving the problem; and receiving a user's input as a solution to the first problem.

This application claims the benefit of priority of U.S. 61/321,843, filed Apr. 7, 2010, the entire specification of which is hereby incorporated herein by reference.

### FIELD

Embodiments of the present invention relate generally to software and systems designed for teaching purposes.

### BACKGROUND OF THE INVENTION

Concrete or physical manipulatives such as blocks, math racks, counter, etc., are used to facilitate learning, especially in the field of mathematics. Virtual manipulatives refer to digital “objects” that are the digital or virtual counterpart of concrete manipulatives. Virtual manipulatives may be manipulated, e.g., with a pointing device such as a mouse during learning activities.

### SUMMARY

Broadly, embodiments of the present invention disclose a number line tool and a method for teaching math based on the number line tool. Advantageously, in one embodiment the number line tool is rendered as a virtual manipulative on a display screen so that a learner may interact with the virtual manipulative to solve math problems and to learn math problem solving techniques. In particular the number line tool may be useful in building an understanding of equivalency between problems e.g. an understanding that 8×3 is equivalent to 4×6. Further, the number line graphic may be useful in teaching/reinforcing problem solving strategies such as double, tripling, grouping by one more or less, etc., as will be explained below.

### BRIEF DESCRIPTION OF THE DRAWINGS

FIGS. 1 to 14 show examples of the number line graphic, in accordance with various embodiments of the invention.

FIG. 15 is an example of hardware for implementing the system of FIG. 1, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrases “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Broadly, embodiments of the present invention disclose a number line tool and a method for teaching math based on the number line tool. Advantageously, in one embodiment the number line tool is rendered as a virtual manipulative on a display screen so that a learner may interact with the virtual manipulative to solve math problems and to learn math problem solving techniques. In particular the number line tool may be useful in building an understanding of equivalency between problems e.g. an understanding that 8×3 is equivalent to 4×6. Further, the number line graphic may be useful in teaching/reinforcing problem solving strategies such as double, tripling, grouping by one more or less, etc., as will be explained below.

The number line tool may be integrated in a system for teaching math. The system may be realized, in one embodiment, as a general-purpose computer comprising suitable instructions for implementing the number line tool and associated method.

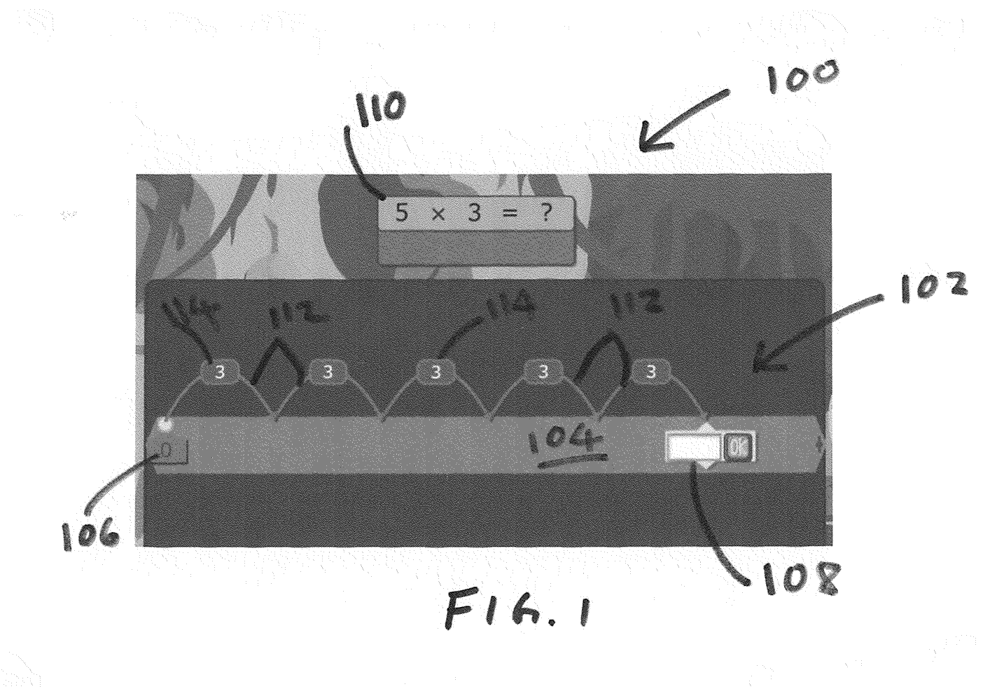

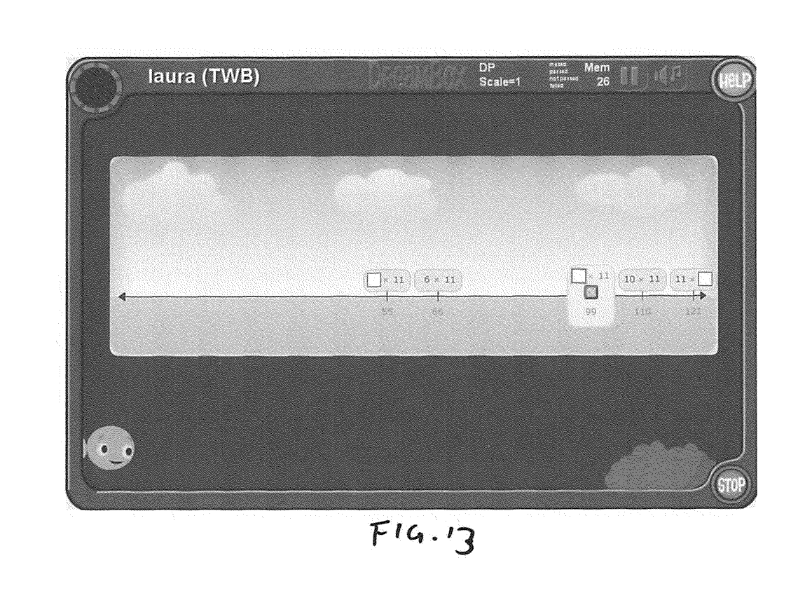

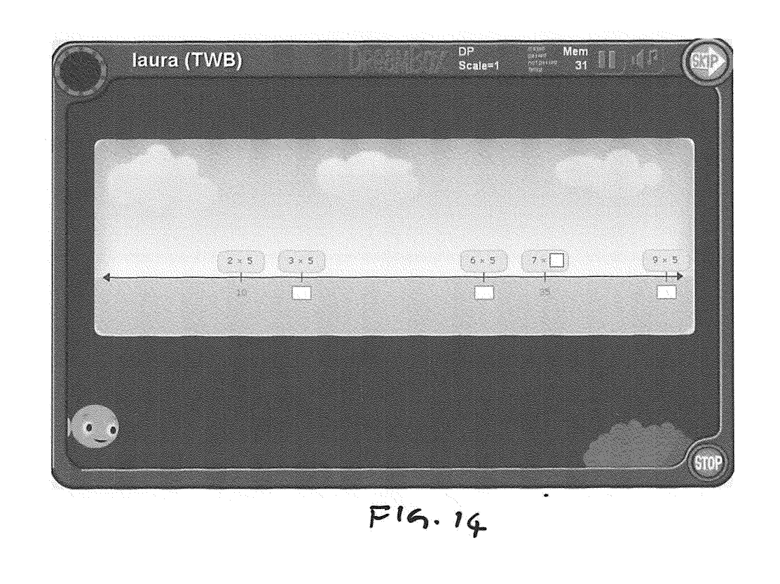

FIGS. 1-14 show screenshots showing aspects of a user interface generated by the number line tool in accordance with different embodiments. In FIG. 1-14 the same reference numerals are used to indicate the same or similar features occurring across the drawings.

Referring to FIG. 1, user interface 100 includes a number line graphic indicated generally by reference numeral 102. The number line graphic 102 comprises a number line portion 104, and markers to indicate the positions of numbers along the number line 102. In particular, marker 106 is used to mark the number “0”, whereas the marker 108 serves as an input box for a learner/student to input an answer to a problem being presented.

A box 110 is provided for displaying a problem/challenge to be solved. In the case of the user interface 100, the particular problem to be solved is a multiplication problem requiring a student to find the product of the factors “5”, and “3”.

To assist the learner in arriving at a correct solution to the problem, guidance is provided. In the example of the user interface 100, the guidance takes the form of a visual indication that the solution to the problem may be computed based on forming five groups of the number “three”. The visual indication comprises arcs/jumps indicated by reference numeral 112. Jump value markers 114 indicate a size of each jump/arc 112. The guidance teaches/reinforces the learning strategy that the problem “5×3” performing five groups of 3″. Advantageously, end points of the arcs/jumps 112 are marked along the number line 104 to indicate the relative value that each arc/jump 112 contributes to the solution.

In the case of the user interface 100, the user is requested to find the product of two factors. In some cases only one factor in product review provided and the user is requested to determine the missing factor.

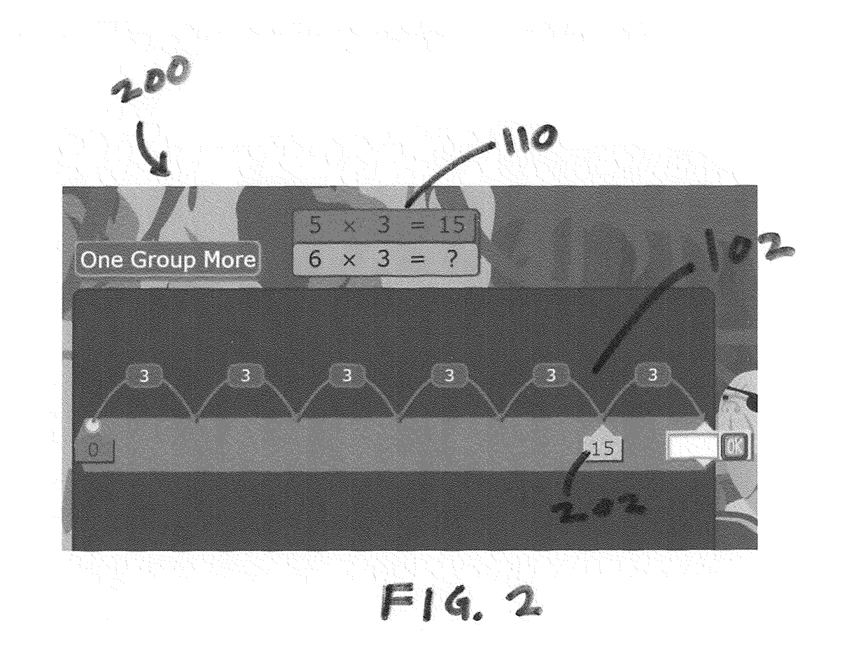

Referring now to FIG. 2 of the drawings, there is shown a user interface 200, in accordance with one embodiment of the invention. In the case of the user interface 200, the problem box 110 shows an additional problem i.e. the problem “6×3=?” Solving this latter problem requires the learner to form six groups of three. Thus, the second problem is different from the previous problem in that one more group of three has to be formed in arriving at the solution. In terms of strategies used to solve the problem, the user can form six groups of three. Alternatively, the user can recognize that five groups of three equals 15 and that the solution may be arrived at by adding one more group to 15. The latter strategy is preferable and guidance is given to use the latter strategy. The guidance includes marker 202 which indicates the relative position of the number “15” on the number line 102 and an arc connecting the marker 102 and the answer marker/box 106 which indicates that the solution is one more group of “3” from base number “15”.

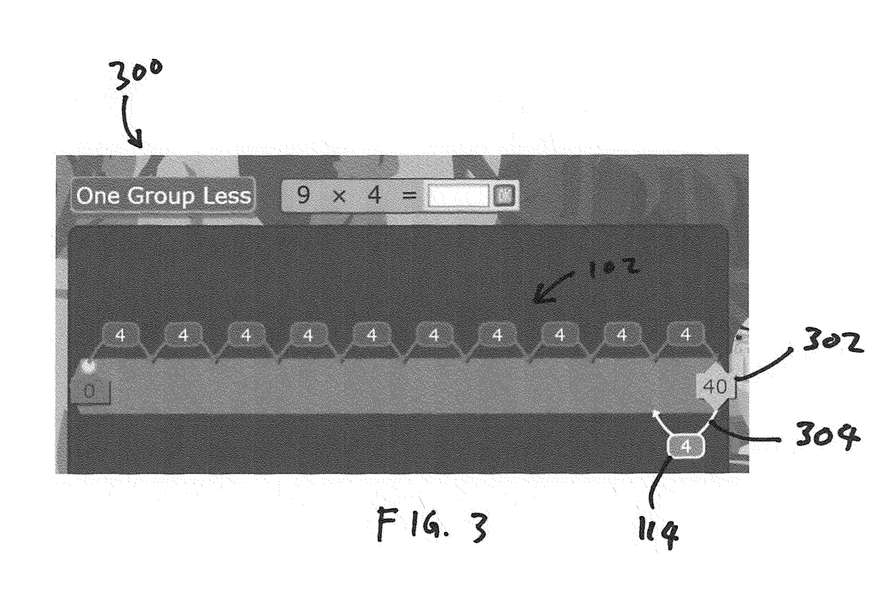

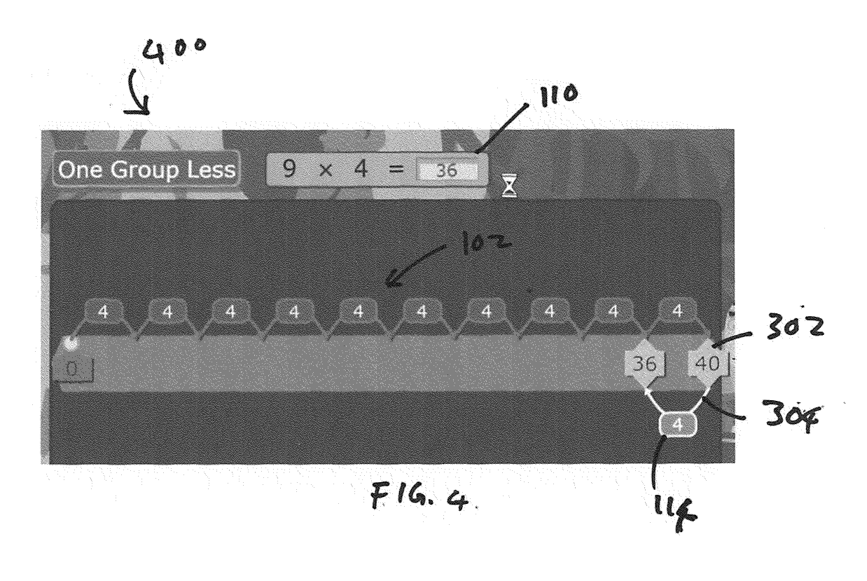

FIG. 3 indicates a UI 300 that provides guidance to teach the strategy of arriving at a solution by forming one group less. The problem to be solved is “9×4=?”. Marker 302 indicates the relative position of the number “40” on the number line 102. A backward arc 304 is drawn from the marker 302 with a jump value marker 114 of “4”. This guides a user to the realization the solution may be formed by grouping ten groups of four and then forming one group less. FIG. 4 illustrates the UI 400 with the solution “36” marked on the number line.

Arcs/jumps may point forwards or backwards along the number line portion 104. Backward arcs provide guidance for the strategy of one group less (see FIG. 4). This makes a more difficult problem easier by explicitly showing the student the relationship between a benchmark problem and a problem that has a factor of one less than the benchmark. For example: 5×8 and 4×8; 10×9 and 9×9

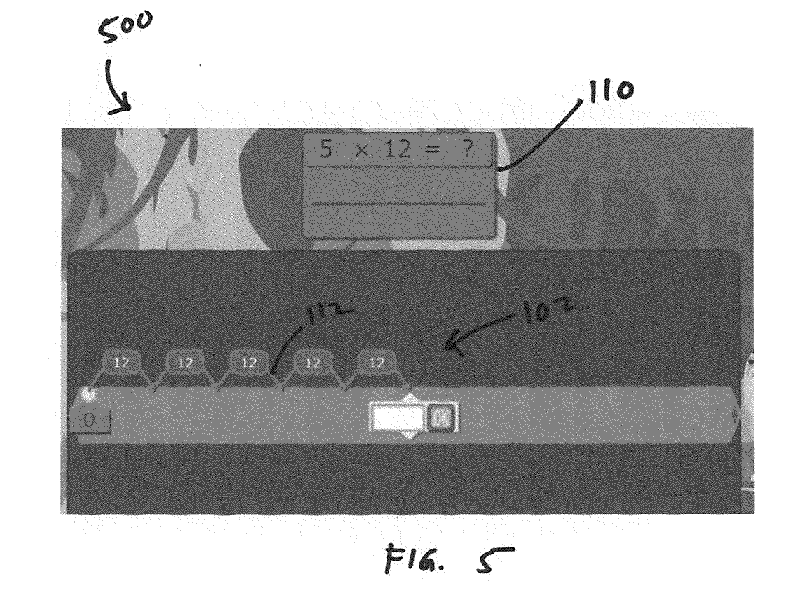

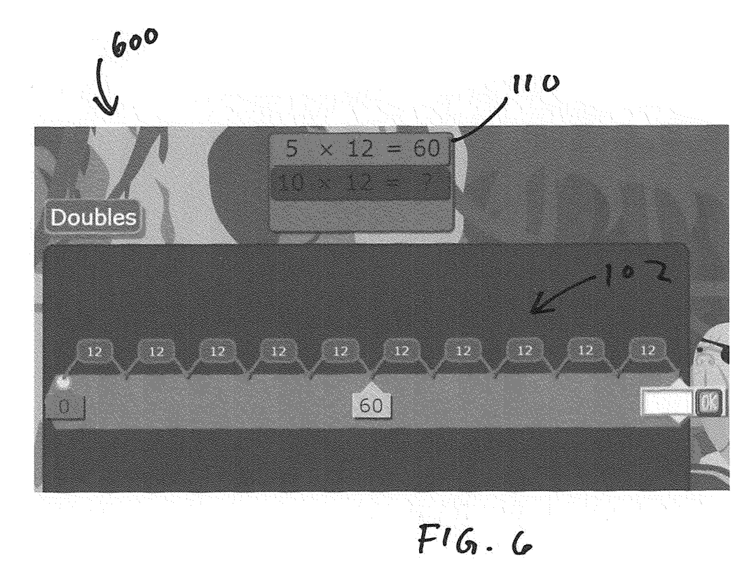

FIGS. 5 and 6 illustrate how the number line tool of the present invention may be used to teach forming doubles as a problem-solving strategy. Referring to FIG. 5, UI 500 shows the problem to be solved is “5×12=?” in the problem box 110. The number line for 102 is displayed and guidance includes appropriately marked jumps/arcs 112 to indicate that the solution may be obtained by forming five groups of 12. FIG. 6 shows the UI 600 after the student has entered the correct solution “60” in the answer box 106 Response to receiving the correct answer, in one embodiment, the problem generator 102 generates a second problem. Advantageously, the second problem is related to the first problem so that the second problem can be solved based on the first problem. In the particular case, the second problem is exactly the same as the first problem save that one of the factors has been doubled. The idea is for the student to come to the understanding that having one of the factors results in doubling the answer. Thus, the student can arrive at the answer to the second problem by simply doubling the answer to the first problem. Alternatively, if the student does not grasp the concept of doubling, then the student is provided the usual guidance in the form of our arc/jumps 112 to indicate that the solution/answer can be formed by grouping 12 groups of 10.

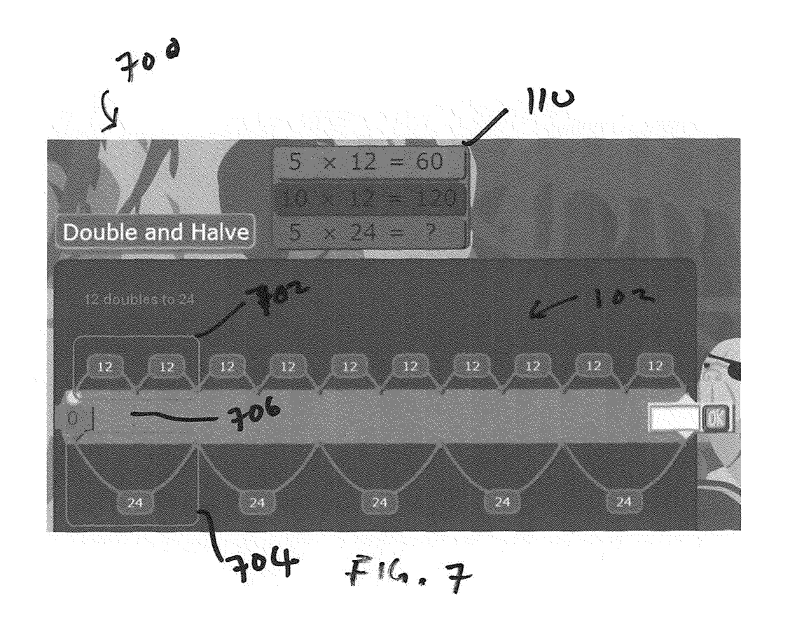

Referring to FIG. 7 of the drawings, UI 700 shows a third problem in the problem box 110. The third problem is related to the second problem in that one of the factors is doubled while the other is halved. Given the sequence in which the problems are presented, the student is expected to come to the understanding that doubling one factor, while halving the other will not affect the answer. Visually, the guidance in the form of arcs/jumps 112 shows that the answer may be formed by forming 5 groups of 24. It is important to note that with the UI 700, guidance is provided both above and below the number line graphic 102. By providing guidance both above and below the number line graphic 102, relationships between problems may be shown. In the particular by providing guidance both above and below the number line graphic, the student is expected to come to an understanding of the equivalence between 10 groups of 12 and 5 groups of 24.

In one embodiment, numbers represented by the arcs/jumps 112 may be grouped together or chunked to indicate numerical equivalents. Chunking of numbers is illustrated in FIG. 7. As will be seen, two jumps of 12 chunked together by forming a peripheral box 702 around the jumps. Another peripheral box 704 is formed around a jump 24 below the number line graphic 102. A connector 706 links the boxes 702 and 704, thereby, to indicate that 2 groups of 12 are numerically equivalent to 1 group of 24. Thus, chunking provides visual guidance to assist a student to come to the understanding that having one factor while doubling the other does not change the answer.

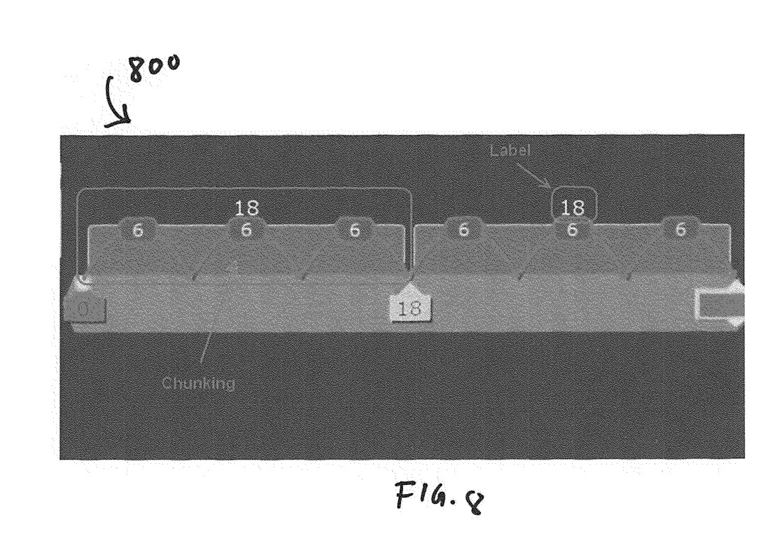

FIG. 8 shows an embodiment 800 of the number line graphic that allows for groups of arcs to be chunked. Chunking may be across arcs both above and below the number line portion 104. Chunking may be of single arcs or of groups of arcs. Arcs chunked together may be labeled with a label that indicates the numerical value of the arcs chunked together. Labels may be expressions e.g.“3×6” or products e.g. “18”. This provides scaffolding by allowing a learner to skip count or add partial products. This also emphasizes the relationship between the number line and the problems to be solved. In one embodiment, the labels may be selectively turned on or off. Chunking provides the user with a visual for a particular strategy to solve a problem.

The embodiment 900 has a marker 902 to mark the midpoint “18” along the number line portion 102. This provides scaffolding to the child by allowing them to skip count. In one embodiment, the arcs/jumps 112 are sequentially highlighted during counting by a user. This allows for scaffolding for students that are still relying on skip counting and moves them toward multiplicative thinking

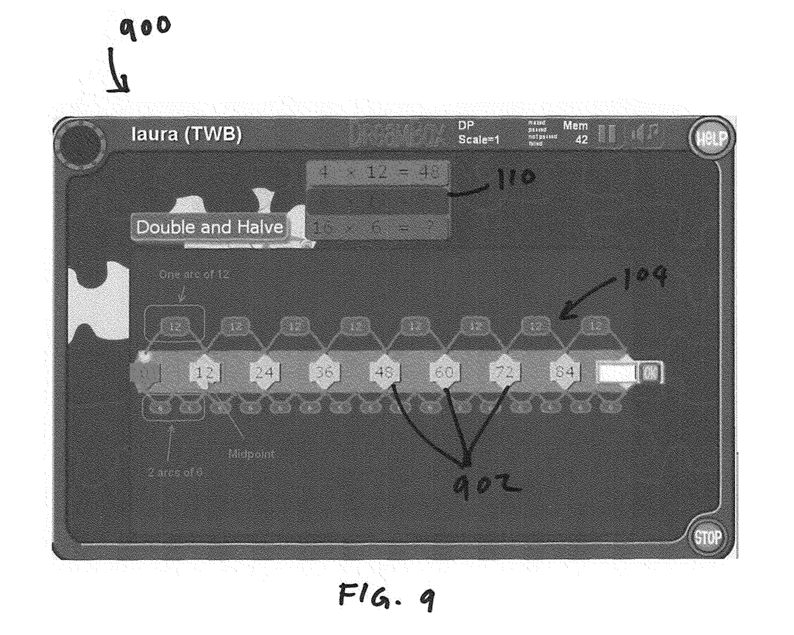

FIG. 9 shows an embodiment of a UI 900. In the UI 900, the arcs/jumps 112 may be in color. Further, the number line graphic 102 allows chunking to the expression being solved by providing intermediate chunking values 902. Chunking to the expression being solved makes the relationship between the number line graph and the problems to solve more explicit.

In the UI 900, the arcs above and below the number line portion 104 are drawn to scale. Thus the arcs of 6 below the number line portion 104 are half the size of arcs of 12 above the number line portion 104. This allows the user a way to check if his/her answer is reasonable. It also allows the user to use visuals to help solve the problem. Example: arcs of 6 on bottom are half the size of arcs of 12 on top.

### Animated Number Line

Embodiments of the present invention also disclose an advanced number line graphic known as an “animated number line”. The animated number line provides a visual representation of multiplication and division. In one embodiment (referred to as “animal jumpers”) the number line introduces students to multiplicative thinking by having them view jumps as a unit. (Example: 6 jumps of 8 vs. 6 single jumps plus 6 more jumps etc.) Another embodiment (referred to as “Number line Mysteries”) helps students learn basic facts.

### Animal Jumpers

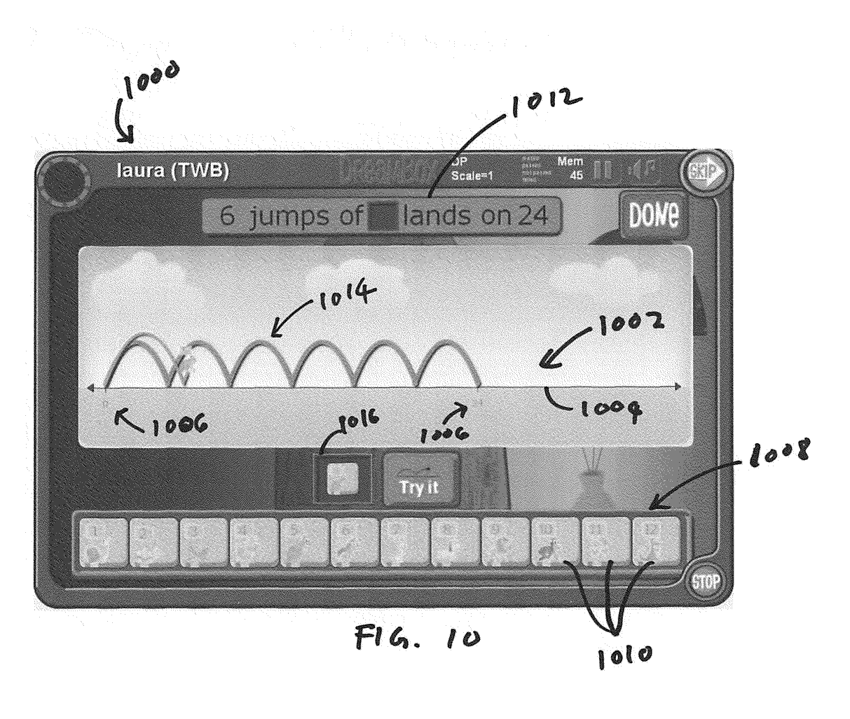

FIG. 10 shows a UI 1000 wherein the animal jumpers animated number line is shown. The animated number line is indicated generally by reference numeral 1002. The animated number line 1002 comprises a number line portion 1004. Markers 1006 indicate the relative position of numbers along the number line portion 1004. A tile bin 1008 comprises a plurality of tiles 1010. Each tile 1010 has a number marked thereon and a representation of an animal. A problem box 1012 displays a problem to be solved. To start with a number of jumps 1014 are shown to indicate the number of jumps of the given factor are required to arrive at the solution. In the case of the problem shown, the number of jumps is “6”. To solve the problem, a student must drag the tile marked with the number “4” from the tile bin 1008 and drop the tile in a tile placement box 1016. Responsive to placement of a tile in the box 1016, the system will animate a series of jumps started at position “0” on the number line portion 1004. The number of jumps in the animation will equal the number indicated on the tile placed in the placement box 1016. If the correct tile is placed in the placement box 1016, then the animation will trace the path of jumps 1014 shown initially. If the incorrect tile is placed in the placement box 1016, then the path of the animation will deviate from the path of the jumps 1014.

In one embodiment of animal jumpers, a student is required to find the landing or endpoint along the number line for an animal appearing at a start position along the number line (usually 0) and a given number of jumps to the endpoint. When the endpoint is correct, the system adds a description of the problem. (Example: 2 jumps of 6 lands on 12). Jumping behavior is tied to sentence above “2 jumps of 6 lands on 12”. This is illustrated in the UI shown in FIG. 10.

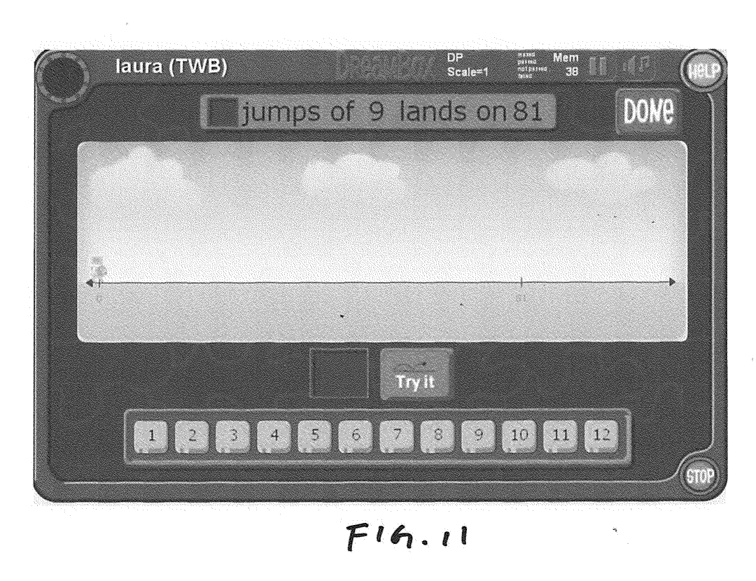

FIG. 11 shows a variation of animal jumpers where a student is given a number line with an animal at the start (0) and an endpoint marked. The student is also shown a description of the problem with the number of jumps missing. Students choose how many jumps the animal must take to land on the endpoint).

In one embodiment of animal jumpers, assistance is provided for wrong answers in the form of highlighting each arc as it is counted off.

In one embodiment of animal jumpers the “jumps of” language in the problem may be replaced with multiplication and division symbols. This moves students from a concrete description (jumps of) to a symbolic representation of multiplication.

In one embodiment of animal jumpers a “Try It” button (see FIG. 11) enables students to check their work and self correct before entering an answer.

### Number Line Mysteries

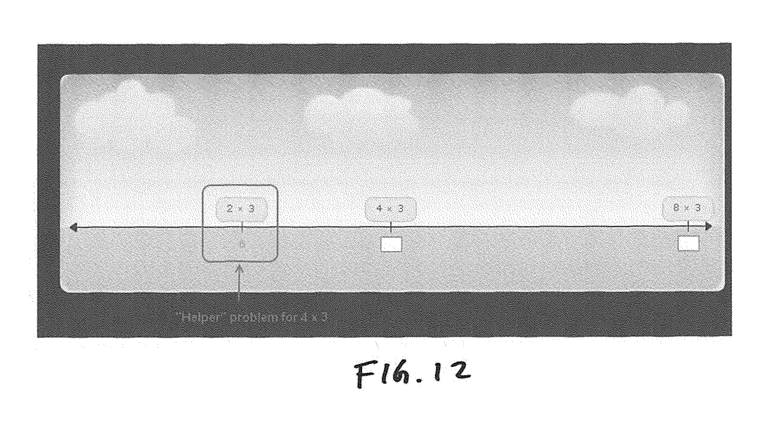

With the number line mysteries version of the number line graphic, a student will be given a number line to solve problems. For example, the expression 2×3 in FIG. 12 is above an empty text box in which a user would be expected to type 6. Points on the number line can show a point as two different values: an expression and/or an endpoint. As a result, problems can be presented in a variety of ways: with a missing factor or a missing product. Number line mysteries may also use efficient strategies for solving multiplication problems, such as doubling, partial products, one group more/less, etc.

FIGS. 12-14 show examples of number line mysteries.

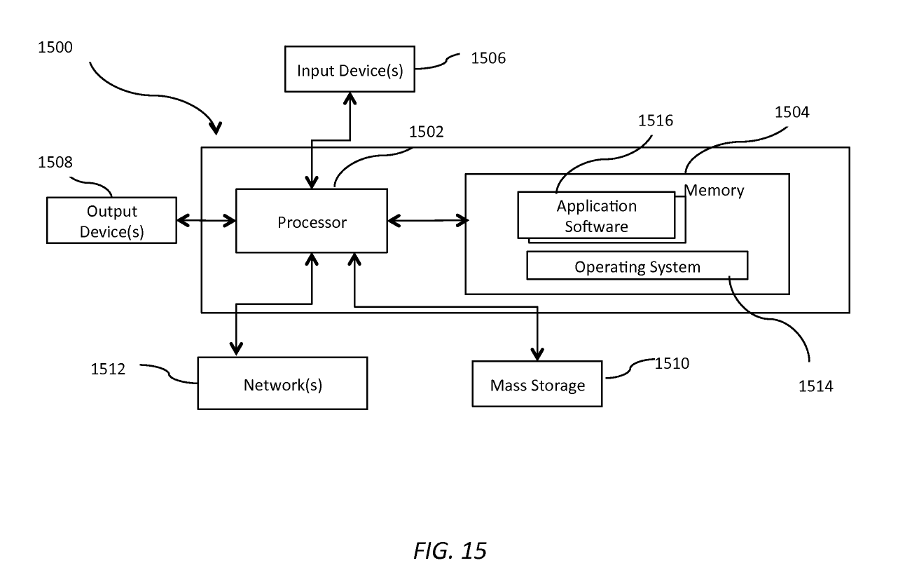

FIG. 15 shows an example of a computer system 1500 for implementing the number line tool described herein. The hardware 1500 may include at least one processor 1502 coupled to a memory 1504. The processor 1502 may represent one or more processors (e.g., microprocessors), and the memory 1504 may represent random access memory (RAM) devices comprising a main storage of the system 1500, as well as any supplemental levels of memory e.g., cache memories, non-volatile or back-up memories (e.g. programmable or flash memories), read-only memories, etc. In addition, the memory 1504 may be considered to include memory storage physically located elsewhere in the system 1500, e.g. any cache memory in the processor 1502 as well as any storage capacity used as a virtual memory, e.g., as stored on a mass storage device 1510.

The system 1500 also typically receives a number of inputs and outputs for communicating information externally. For interface with a user or operator, the system 1500 may include one or more user input devices 1506 (e.g., a keyboard, a mouse, imaging device, etc.) and one or more output devices 1508 (e.g., a Liquid Crystal Display (LCD) panel, a sound playback device (speaker, etc.).

For additional storage, the system 1500 may also include one or more mass storage devices 1510, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 1500 may include an interface with one or more networks 1512 (e.g., a local area network (LAN), a wide area network (WAN), a wireless network, and/or the Internet among others) to permit the communication of information with other computers coupled to the networks. It should be appreciated that the system 1500 typically includes suitable analog and/or digital interfaces between the processor 1502 and each of the components 1504, 1506, 1508, and 1512 as is well known in the art.

The system 1500 operates under the control of an operating system 1514, and executes various computer software applications, components, programs, objects, modules, etc. to implement the techniques described above. Moreover, various applications, components, programs, objects, etc., collectively indicated by reference 1516 in FIG. 15, may also execute on one or more processors in another computer coupled to the system 1500 via a network 1512, e.g. in a distributed computing environment, whereby the processing required to implement the functions of a computer program may be allocated to multiple computers over a network. The application software 1516 may include a set of instructions which, when executed by the processor 1502, causes the system 1500 to generate the number line tool described.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific example embodiments, it will be evident that various modifications and changes can be made to these embodiments without departing from the broader spirit of the invention. Accordingly, the specification and drawings are to be regarded in an illustrative sense rather than in a restrictive sense.

1. A computer-implemented method for teaching math, comprising:
displaying a number line graphic to indicate a relative order between numbers;
generating a first problem comprising numbers at least some of which are indicated on the number line graphic;
selectively providing guidance for solving the problem; and
receiving a user's input as a solution to the first problem.

2. The method of claim 1, further comprising evaluating a correctness of the user's input and generating at least one second problem based on the evaluation.

3. The method of claim 1, wherein the guidance is provided prior to receiving the user's input.

4. The method of claim 1, wherein the guidance is provided after receiving the user's input.

5. The method of claim 1, wherein the first problem comprises a multiplication problem which includes a multiplicand, a multiplier, and a product of the multiplicand and the multiplier; wherein a user is required to solve for one of the multiplicand, multiplier, and product

6. The method of claim 1, further comprising indicating at least one of the multiplicand and the product on the number line graphic.

7. The method of claim 1, further comprising generating second problem, wherein the second problem is related to the second problem.

8. The method of claim 1, wherein the guidance comprises arcs indicating a number of hops of a given number between first and second numbers on the number line graphic.

9. A system, comprising:
a processor; and
a memory coupled to the processor, the memory storing instructions which when executed by the processor, causes the system to perform a method, comprising:
displaying a number line graphic to indicate a relative order between numbers;
generating a first problem comprising numbers at least some of which are indicated on the number line graphic;
selectively providing guidance for solving the problem; and
receiving a user's input as a solution to the first problem.

10. The system of claim 9, wherein the method further comprises evaluating a correctness of the user's input and generating at least one second problem based on the evaluation.

11. The system of claim 9, wherein the guidance is provided prior to receiving the user's input.

12. The system of claim 9, wherein the guidance is provided after receiving the user's input.

13. The system of claim 9, wherein the first problem comprises a multiplication problem which includes a multiplicand, a multiplier, and a product of the multiplicand and the multiplier; wherein a user is required to solve for one of the multiplicand, multiplier, and product.

14. The system of claim 9, wherein the method further comprises indicating at least one of the multiplicand and the product on the number line graphic.

15. The system of claim 9, wherein the method further comprises generating a second problem, wherein the second problem is related to the second problem.

16. The system of claim 9, wherein the guidance comprises arcs indicating a number of hops of a given number between first and second numbers on the number line graphic.

17. A computer-readable medium having stored thereon a sequence of instructions which when executed by a system causes the system to perform a method, comprising:
displaying a number line graphic to indicate a relative order between numbers;
generating a first problem comprising numbers at least some of which are indicated on the number line graphic;
selectively providing guidance for solving the problem; and
receiving a user's input as a solution to the first problem.

18. The computer-readable medium of claim 17, wherein the method further comprises evaluating a correctness of the user's input and generating at least one second problem based on the evaluation.

19. The computer-readable medium of claim 17, wherein the guidance is provided prior to receiving the user's input.

20. The computer-readable medium of claim 17, wherein the guidance is provided after receiving the user's input.
